(19) United States
(12) Patent Application Publication
(10) Pub. No.: US 2012/0206261 A1
(43) Pub. Date: Aug. 16, 2012

(54) ACOUSTIC REPRESENTATION OF STATES OF AN INDUSTRIAL PLANT

(76) Inventors: Matthias Dürr, Nurnberg (DE); Norbert Gewald, Erlangen (DE)

(21) Appl. No.: 13/499,011

(22) PCT Filed: Sep. 15, 2010
(86) PCT No.: PCT/EP10/05674

§ 371 Date: Apr. 27, 2012

(30) Foreign Application Priority Data
Sep. 30, 2009 (DE) 10 2009 047 783.7

(51) Int. Cl. G08B 21/00

(52) U.S. Cl. 340/540

(57) ABSTRACT

A machine classifier classifies signals of an industrial plant and determines a current state as a result. On the basis of the current state, an audio profile is selected from a number of audio profiles and issued in the form of a synthetically generated acoustic signal to a plant operator. For that purpose, the state of the industrial plant is continuously evaluated and, for example, with the aid of a MIDI sequencer, is used to manipulate different tracks of a piece of music or of synthetically generated artificial background noise. In this way, the plant operator is able to discern intuitively, and optionally even subliminally, divergences from a normal operation of the industrial plant, which can only be communicated to the operator via the overloaded visual channel with great difficulty, or not at all. The plant operator can therefore learn of the state of the industrial plant via the auditory sense or learn that in certain situations the industrial plant does not sound right. Since for that purpose use is made of a comparatively underused sensory channel with the acoustic perception, even small changes in the acoustic signal produce a high level of alertness in the plant operator.

### CROSS-REFERENCE TO RELATED APPLICATIONS

This application is a U.S. National Stage Application of International Application No. PCT/EP2010/005674 filed Sep. 15, 2010, which designates the United States of America, and claims priority to DE Patent Application No. 10 2009 047 783.7 filed Sep. 30, 2009. The contents of which are hereby incorporated by reference in their entirety.

### TECHNICAL FIELD

The disclosure relates to methods and arrangements for acoustic representation of different states of an industrial plant.

### BACKGROUND

In line with today's digitalization, industrial plants such as power stations or factories, for instance, often include man-machine interfaces via which a plant operator monitors the industrial plant. The man-machine interface makes it possible for the plant operator to control the plant. For this purpose, thousands of signals in the form of sensor signals, operating states and other data, for example, are processed and displayed in visual form to the plant operator via monitors. For example, certain operating states of the industrial plant can be measured only via sensors and shown exclusively in visual form on the monitors. Audible warning signals are output on the audio channel according to special events, such as faults for instance.

A method is known from DE 603 01 760 T2 in which an audible signal (for example blinker noise) is output in accordance with a state of a motor vehicle (for instance speeding, turn indicator activated). In this connection the state includes an operating state and a travel state. The assignment of the audible signals is implemented as a tabular assignment.

Furthermore, a method is known from DE 197 01 801 A1 in which an artificial engine noise is generated and output as an audible signal for an electrically-driven motor vehicle. In this case characteristics of the audible signal are employed, which are directly related to a speed of the motor vehicle.

One problem is to state a method and an arrangement for the representation of states of an industrial plant, which simplify and if necessary improve the monitoring of the state of the industrial plant for a plant operator.

### SUMMARY

In one embodiment, a method is provided for the acoustic representation of states of an industrial plant, wherein signals of the industrial plant are processed with a machine classifier, it being possible for a current state of the industrial plant to be determined as a result, wherein with the aid of a computer and the current state, an audio profile is selected from a number of audio profiles, wherein the audio profile is converted into an acoustic signal, and wherein the acoustic signal is output to a plant operator.

In a further embodiment, the machine classifier is a program of a plant automation system, an expert system, a neural network or a support vector machine. In a further embodiment, the signals come from over a thousand different sources, the signals are filtered, weighted, aggregated and/or abstracted prior to or during the processing with the machine classifier, and apart from the signals, the machine classifier processes signal trends, key performance indicators and/or data from a production control system, a corporate resource planning system, a system for production planning and control, and/or archiving.

In a further embodiment, the current state is a normal operation, start-up, shut-down, ready state, idle state or malfunction of the industrial plant. In a further embodiment, the audio profiles are standardized from the number of audio profiles. In a further embodiment, the industrial plant is a power station or a factory. In a further embodiment, the audio profile has an interface via which profile parameters of the audio profile are configurable by means of the current state. In a further embodiment, the acoustic signal is assembled from a plurality of tracks which are synthetically generated with the aid of a sequencer, and each track of the acoustic signal is influenced by a profile parameter of the audio profile.

In a further embodiment, the acoustic signal is a noise, a noise in conjunction with a signal tone, a noise in conjunction with a parameter-dependent tone, a constant background noise or a piece of music. In a further embodiment, the tracks form a score of a piece of music as the acoustic signal. In a further embodiment, the acoustic signal is generated by synthesized sound or sampling.

In another embodiment, a computer-readable data medium storing a computer program is provided, the computer program being processed in a computer to implement any of the methods disclosed herein. In yet another embodiment, a computer program is provided for implementing any of the methods disclosed herein.

In yet another embodiment, an arrangement for the acoustic representation of states of an industrial plant comprises: a machine classifier programmed for processing signals of the industrial plant and for determining a current state of the industrial plant, a first processing unit, programmed for selecting an audio profile from a number of audio profile by means of the current state; a second processing unit, programmed for converting the audio profile into an acoustic signal; and an interface to a tone generator, which is connected to an acoustic output means and is designed to output the acoustic signal to a plant operator.

In a further embodiment, the arrangement is set up for processing signals from over a thousand different sources, wherein the industrial plant is a power station or a factory. In a further embodiment, the first processing unit sets profile parameters of the audio profile according to the current state or to the signals, the second processing unit includes a sequencer, which has an interface for receiving the audio profile, and the sequencer is set up to synthetically generate a plurality of tracks, to influence each track by means of a profile parameter and for the composition of the acoustic signal from the tracks. In a further embodiment, the second processing unit includes a synthesizer or sampler, which generates the acoustic signal.

### BRIEF DESCRIPTION OF THE DRAWINGS

Example embodiments will be explained in more detail below with reference to figures, in which:

FIG. 1 shows an acoustic representation of states of an industrial plant, according to an example embodiment; and

FIG. 2 shows a detailed view of the generation and outputting of an acoustic signal, according to an example embodiment.

### DETAILED DESCRIPTION

Some embodiments process signals of an industrial plant using a machine classifier to determine a current state of the industrial plant. Based on the determined current state, an audio profile is selected from a number of audio profiles using a computer. The audio profile is converted into an acoustic signal which is then output to a plant operator.

The arrangement for the acoustic representation of states of an industrial plant may include a machine classifier programmed to process signals of the industrial plant and to determine a current state of the industrial plant. The arrangement may also include a first processing unit which is programmed to select an audio profile from a number of audio profiles from the current state. Thirdly, the arrangement may include a second processing unit which is programmed to convert the audio profile into an acoustic signal. Furthermore, the arrangement may include an interface to a tone generator which is connected to an acoustic output means and designed to output the acoustic signal to a plant operator.

Previously—before the digital age—the plant operator was able to go through the industrial plant and sometimes hear whether there were mechanical problems. The method and the arrangement provides such an emotional, subliminal contact for the plant operator of the industrial plant. Compared to previous man-machine interfaces, the acoustic awareness of the plant operator is no longer pushed into the background and for the first time is again used as an option for additional plant supervision.

The methods and arrangements disclosed herein provide a replacement for the earlier, natural mechanical operating noise of the industrial plant. As a result, the plant operator is again in a position to examine whether the industrial plant sounds right, although the acoustic signal is not the actual operating noise but is a synthetically generated signal.

Consequently, the plant operator can again learn of the state of the industrial plant via the auditory sense. If the acoustic signal changes, the alertness of the plant operator is triggered automatically, like for example the change in travel noise in a motor vehicle alerts the driver and draws his attention to the fact that the fuel pump sounds unusual or even no longer whirrs or the brakes squeal in an unusual way.

The newly created acoustic and consequently also the emotional option for the plant operator to perceive the state of the industrial plant, supplements visual awareness in a meaningful way within the context of the man-machine interface and its optical output means. Consequently, the plant operator can now monitor the industrial plant intuitively, even over long periods of time. He is able to detect the state of the industrial plant quicker and more completely but nevertheless in a detailed manner. This was previously not possible by straight-forward examination of numerous values on optical output means.

For example, in addition to the visual examination of a screen display of the man-machine interface of the industrial plant, a plant operator would also hear the acoustic signal for a few minutes several times a day, or continuously in the background, and thus discover irregularities which would escape his attention in the case of a purely visual examination.

A further advantage of certain embodiments is that the plant operator is now provided with a continuous reference signal in the form of the acoustic signal on a seldom overloaded sensory channel, so that even a small change in the acoustic signal can produce a high level of alertness in the plant operator.

According to one embodiment, the machine classifier is a program of a plant automation system, an expert system, a neural network or a support vector machine. This embodiment has the advantage that well over 1000 signals, which usually have to be evaluated in the industrial plant, can be processed by the machine classifier.

In a further development, the signals come from over 1000 different sources. Furthermore, these signals are filtered, weighted, aggregated and/or abstracted prior to or during the processing with the machine classifier. Apart from the signals, the machine classifier processes signal trends, key performance indicators and/or data from a production control system, a corporate resource planning system, a system for production planning and control and/or archiving.

The effect of the filtering, weighting, aggregation and abstraction of the signals named in this further development is to simplify the acoustic signal which is output to the plant operator. Because of the large number of signals, direct connection of the individual signals to the dynamically generated acoustic signal would overtax the plant operator. Instead, one state whose audio profile is easily recognized by the plant operator is determined (from a limited number of states).

In a further development the current state is normal operation, start-up, shut-down, ready state, idle state or malfunction of the industrial plant.

According to one embodiment, the audio profiles are standardized from a number of audio profiles. This embodiment has the advantage that the plant operator visits quite different industrial plants and, despite this, with the aid of the acoustic signal can recognize which situation is present. Consequently, a similar effect to that in Airbus cockpits is produced which is very similar in all Airbus machines, for example in the A380 and in the A319. Standardization therefore offers the advantage that, even on different plants, states of the industrial plant can be immediately recognized. This makes the training and deployment of personnel for plant control easier.

In addition to the methods and arrangements, a computer-readable data medium storing a computer program executable by a computer to implement methods described above is provided, as well as a computer program for implementing such methods.

### EXAMPLE

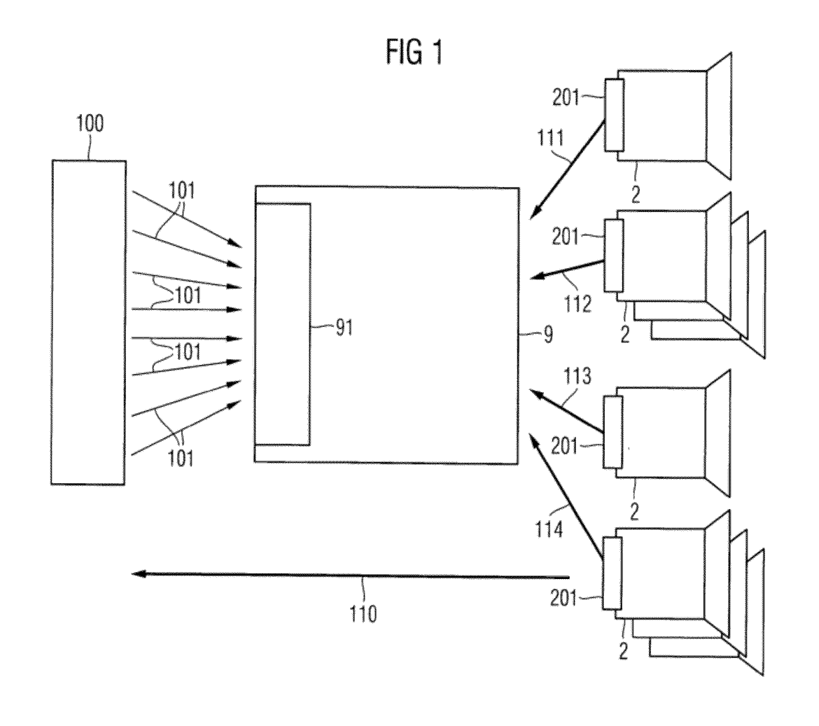

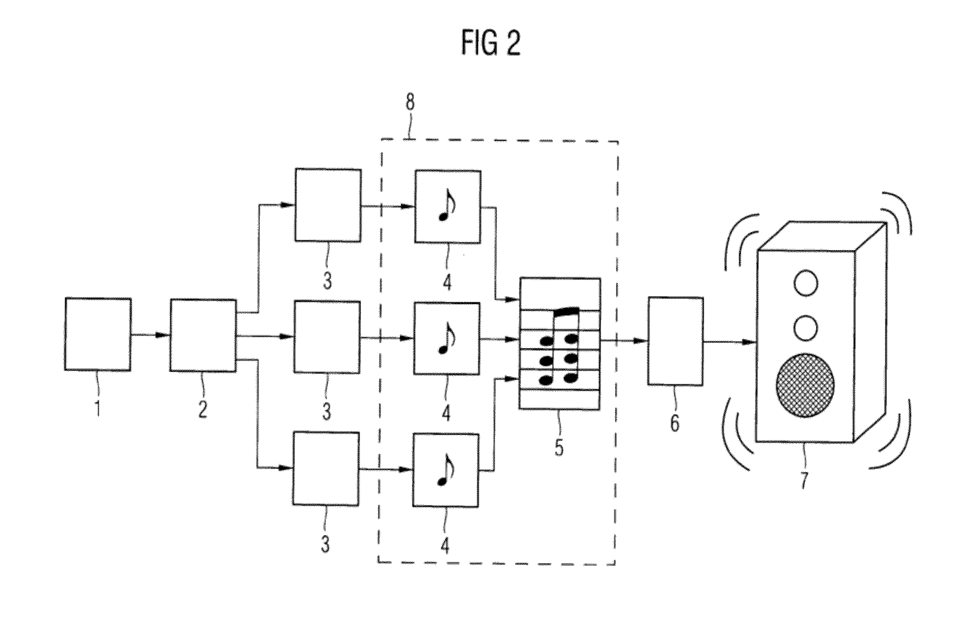

FIG. 1 shows an acoustic representation of states of an industrial plant 100, according to an example embodiment. A machine classifier 9 processes signals 101 of the industrial plant 100 and as a result determines a current state of the industrial plant 100. Depending on the current state, an audio profile 2 is selected from a number of audio profiles 2. The selected audio profile 2 is then converted into an acoustic signal and output to a plant operator. The latter steps are shown in detail in FIG. 2.

Furthermore, FIG. 1 shows a first linkage 111 which links one of the audio profiles 2 with a specific state of the industrial plant 100. This could be the “start-up” state for example. A second linkage 112 links three instances of an audio profile 2 with a further state of the industrial plant 100. In this case it could be a “normal operation” state of the industrial plant 100, for example.

Each of the audio profiles 2 has an interface 201. Profile parameters of the audio profile 2 can be matched to characteristics of the respective state via the interface 201. A characteristic of the “normal operation” state could indicate whether the industrial plant 100 is operated at low, medium or high utilization. Depending on this characteristic, an associated profile parameter of the assigned audio profile 2 could be set via the interface 201 so that a slow, medium-speed or fast piece of music is played in accordance with the characteristic. In the case of the three instances of the audio profile 2 shown overlapping, there can thus be different instances of the same audio profile 2, which differ only by the values of their profile parameters.

A third linkage 113 links a further audio profile 2 with a further state of the industrial plant 100, for example the “shut-down” state. Finally, a fourth linkage 114 is shown, which links several instances of an audio profile 2 with a further state, for example “malfunction”. The “malfunction” state can in turn be characterized by different characteristics which distinguish the degree of severity of the malfunction. Depending on this characteristic, corresponding parameters are again transmitted to the audio profile 2 via the interface 201, which generates one of the possible instances with the aid of the corresponding profile parameters.

Furthermore, FIG. 1 shows a development phase 110, indicated by an arrow drawn from right to left. The audio profiles 2 are started in the development phase 110. Ideally, these audio profiles already exist in a standardized form, that is to say they are standardized for typical states of industrial plants. This has the advantage that a plant operator visits different the industrial plants and can immediately inform himself because acoustic signals are output everywhere with the same audio profiles 2. In the development phase 110 the existing audio profiles 2 are linked backwards with the states of the industrial plant 100. Here it is also determined how characteristics of the states are to affect profile parameters of the audio profiles 2.

However, in a following and essentially more complex step of the development phase 110, the states of the industrial plant 100 have to be derived from their individual signals 101. For example, a filter 91 which is connected upstream of the machine classifier 9 or is a constituent part of the machine classifier 9, is used for this. The signals 101 which can come from over a thousand different sources are filtered, weighted, aggregated and/or abstracted by the filter 91 prior to or during the processing with the machine classifier 9. Furthermore, during the detection of the current state or for determining the characteristics of the current state, in addition to the signals 101, the machine classifier 9 can also process signal trends 101, operational key indicators (“key performance indicators”—KPI) and/or data from a production control system (“manufacturing execution system”—MES), a corporate resource planning system (“enterprise resource planning”—ERP), a system for production planning and control (“production planning system”—PPS) and/or archiving. For determining the characteristics of the states, recourse can be made to data such as quality data or availability data, which can be obtained from said systems. The signals 101 and the numerous other named information sources are therefore allocated to states, it being possible for this to be an m:n type allocation.

Following conditioning and filtering of the more than a thousand signals 101 of the industrial plant 100 by the filter 91, these data are classified by the machine classifier 9 in order to detect a current state and determine its characteristics. In the development phase 110 the reverse path is taken by first defining states of the industrial plant 100. These are then linked with the abstracted signals of the industrial plant 100. The audio profiles 2 remain the same in the development phase 110, that is to say an audio profile 2 for normal operation is not changed. Instead, the definition of the “normal operation” state is matched to the respective design of the industrial plant 100.

In normal operation of the industrial plant 100, a constant background noise is generated as the audio profile 2. In this case, signals of individual motors are not directly considered. The audio profiles 2 can be implemented as noise, noise with a signal tone, noise with a parameter-dependent tone or pieces of music, for example.

The machine classifier 9 can, for example, be implemented as a program of a plant automation system, as an expert system, as a neural network or as a support vector machine. In the first case, the plant automation system is appropriately programmed to execute the process steps described above. A neural network offers the advantage that on the one hand it is very well suited to filtering, weighting, aggregation and abstraction of the signals 101. A neural network is therefore also specially suitable for the filter 91. However, the filter 91 can also be an input layer of a neural network, which is realized by the machine classifier 9. A further advantage of a neural network is that classification by means of data sets can be automatically learnt. In this case, the rules by which the more than one thousand signals 101 are to be classified to states do not have to be explicitly stated. Instead, data sets are collected for different states of the industrial plant 100. In each case the data sets are annotated with the respective state. The neural network is then trained with the data sets and is subsequently able to classify the state independently.

FIG. 2 shows a detailed view of the generation and output of an acoustic signal 5, according to an example embodiment. As previously described, firstly an audio profile 2 is selected in accordance with a current state 1, it being possible for profile parameters 3 of the audio profile 2 to be set in relation to characteristics of the current state 1. The objective is now to also make the current state 1 of the industrial plant 100 accessible to the plant operator acoustically, said current state being previously displayed only visually. The current state 1 of the industrial plant 100 should therefore be conditioned and output acoustically. In this connection, one option is the generation of an acoustic background as an acoustic signal 5, which with deviations from a normal case varies according to changed parameters of the industrial plant 100.

This should be distinguished from acoustic alarm signaling since in that case an acoustic output occurs only in event of a fault. Rather, according to the example embodiment, a continuous acoustic output ensues, which then also occurs when no fault exists. This has the advantage that the plant operator can perceive even small deviations from a normal state and be informed by means of an acoustic signal, not just in the event of a fault.

According to the example embodiment, FIG. 2 shows an acoustic signal 5 which is output to the plant operator via a tone generator 6 and an acoustic output means 7, for example a loudspeaker. In this case the acoustic signal 5 is synthetically generated by a sequencer 8, for example. Alternately, a synthesizer or sampler can be employed. As shown by the arrows in FIG. 2, in this case the current state 1 of the industrial plant 100 influences the acoustic signal 5. According to the example embodiment, here the influence on the acoustic signal 5 by the current state 1 is continuous, that is to say the current state 1 of the industrial plant 100 is determined or evaluated continuously and employed continuously for the matching of the acoustic signal 5. This particularly relates to time intervals in which there is no fault in the industrial plant 100, or at least no fault is detected in the industrial plant 100.

A sampler is an electronic musical instrument frequently controlled via the MIDI data transmission protocol, which records tones of any kind and can play them back at different pitches. A sequencer is an electronic arrangement or a computer program for recording, playing back and handling music. A synthesizer is a musical instrument which produces electronic tones by synthesizing sounds. MIDI (“musical instrument digital interface”) is a data transmission protocol for transmission of musical control data between electronic musical instruments such as keyboards, synthesizers, computers, etc. The function of the synthesizer 8 shown in FIG. 2 can be realized for example by a MIDI sequencer in software or hardware, but also by alternate implementations by means of one or a plurality of samplers or synthesizers.

FIG. 2 also shows that each of the profile parameters 3 influence one track 4 of the acoustic signal 5. The different tracks 4 are assembled by the sequencer 8 to form the acoustic signal 5.

FIG. 2 therefore shows an acoustic construction of the acoustic signal 5, as well as a manipulation of its individual tracks 3. Here an implementation of the sequencer 8 is realized, based on sequencers for generating music, for example. Suitable sequencers in hardware or software are well known and enable samples or synthesized signals to be managed on the different tracks 4, and to be played back together as the acoustic signal 5. In this connection, the played-back tracks 4 can be manipulated by a wide variety of methods. So for instance, it is possible to dynamically change pitch, response time, loudness, etc.

According to the example embodiment, the individual profile parameters 3 which correlate with selected characteristics of the current state 1 of the industrial plant 100, are now coupled to the sequencer 8. Each relevant profile parameter 3 therefore influences a controlled variable of the assigned track 4 in the sequencer 8. However, a profile parameter 3 can also influence a controlled variable for a plurality of or all tracks 4, for instance the loudness or speed of all tracks 4.

According to a first variant of the example embodiment, the tracks 4 or the acoustic signal 5 reproduce a piece of music. In this case, the reproduction by the sequencer 8 of the profile parameters 3 on controlled variables (pitch, response time, loudness, etc.) for the tracks 4 is calibrated so that the piece of music in the form of the acoustic signal 5 in a normal or fault-free current state 1 of the industrial plant 100 is played back in an entirely normal way. If, however, characteristics or the profile parameters 3 correlated to them depart from the normal operation of the industrial plant 100, they influence via the sequencer 8 the respective controlled variables (pitch, response time, loudness etc,) of the respective track 4. In this case, for instance, the pitch of the melody of the piece of music can vary or the timing of its rhythm change slightly. For example, one of the instruments synthetically generated by MIDI can also become louder and stand out.

This therefore enables the plant operator to receive a subliminal impression of the normal state of the industrial plant 100. With variations in the characteristics of the current state or the profile parameters 3, the individual tracks 4 are likewise distorted, as described above in the case of the first variant, in order to make the plant operator aware of the deviation.

Furthermore, with a change of state of the industrial plant 100 the audio profile 2 also immediately changes, so that the plant operator directly receives a clear acoustic status signal concerning the change of state.

In another variant, the acoustic signal 5 does not represent a piece of music, but just an abstract acoustic signal. Here the abstract acoustic signal can be implemented as noise, for example. In this connection, splitting-up of the abstract acoustic signal or its generation from different tracks 4 is optional and can also be omitted. The same also applies to the preceding variants in which the acoustic signal 5 does not necessarily have to be assembled from a plurality of tracks 4. In principle, even a single track 4 is sufficient, which can then be considered to be identical to the acoustic signal 5.

Regarding the development of the abstract acoustic signal as noise, here again a variation of the noise (loudness or possibly clicking or crackling) draws the attention of the plant operator to the current state 1 of the industrial plant 100.

What is claimed is:

1. A method for the acoustic representation of states of an industrial plant,
processing signals of the industrial plant using a machine classifier to determine current state of the industrial plant,
based on the determined current stated of the industrial plant, selecting an audio profile from a number of audio profiles using a computer,
converting the audio profile into an acoustic signal, and
outputting the acoustic signal to a plant operator.

2. The method of claim 1, wherein the machine classifier is one of a program of a plant automation system, an expert system, a neural network, and a support vector machine.

3. The method of claim 1,
wherein the signals are obtained from over a thousand different sources,
wherein prior to or during the processing with the machine classifier, the signals are at least one of filtered, weighted, aggregated, and abstracted, and
wherein, apart from the signals, the machine classifier processes at least one of signal trends, key performance indicators, and data from at least one of a production control system, a corporate resource planning system, a system for production planning and control, and archiving.

4. The method of claim 1, wherein the current state is one of a normal operation state, a start-up state, a shut-down state, a ready state, an idle state, and a malfunction state of the industrial plant.

5. The method of claim 1, wherein the audio profiles are standardized from the number of audio profiles.

6. The method of claim 1, wherein the industrial plant is a power station or a factory.

7. The method of claim 1, wherein the audio profile has an interface via which profile parameters of the audio profile are configurable according to the current state.

8. The of claim 1,
wherein the acoustic signal is assembled from a plurality of tracks which are synthetically generated with the aid of a sequencer, and
wherein each track of the acoustic signal is influenced by a profile parameter of the audio profile.

9. The method of claim 1, wherein the acoustic signal is one of a noise, a noise in conjunction with a signal tone, a noise in conjunction with a parameter-dependent tone, a constant background noise, and a piece of music.

10. The method of claim 1, wherein the tracks form a score of a piece of music as the acoustic signal.

11. The method of claim 1, wherein the acoustic signal is generated by synthesized sound or sampling.

12. (canceled)

13. A computer program stored in non-transitory computer-readable media and executable by a processor to:
process signals of the industrial plant using a machine classifier to determine a current state of the industrial plant,
based on the determined current stated of the industrial plant, select an audio profile from a number of audio profiles using a computer,
convert the audio profile into an acoustic signal, and
output the acoustic signal to a plant operator.

14. An arrangement for the acoustic representation of states of an industrial plant, comprising:
a machine classifier programmed for processing signals of the industrial plant and for determining a current state of the industrial plant,
a first processing unit programmed for selecting an audio profile from a number of audio profile by means of the current state,
a second processing unit programmed for converting the audio profile into an acoustic signal, and
an interface to a tone generator, which is connected to an acoustic output means and is designed to output the acoustic signal to a plant operator.

15. The arrangement of claim 14,
wherein the arrangement is configured for processing signals from over a thousand different sources, and
wherein the industrial plant is a power station or a factory.

16. The arrangement of claim 14,
wherein the first processing unit sets profile parameters of the audio profile according to the current state or to the signals,
wherein the second processing unit includes a sequencer, which has an interface for receiving the audio profile, and
wherein the sequencer is set up to synthetically generate a plurality of tracks, to influence each track by means of a profile parameter and for the composition of the acoustic signal from the tracks.

17. The arrangement of claim 14, wherein the second processing unit includes a synthesizer or sampler, that generates the acoustic signal.
